(19) United States
(12) Patent Application Publication
(10) Pub. No.: US 2008/0195301 A1
(43) Pub. Date: Aug. 14, 2008

(54) Onboard Runway Incursion Alert Method and Device for Aircraft

(75) Inventors: Bernard Fabre, Fonsorbes (FR); Sylvain Fontaine, Villeneuve Tolosane (FR); Nicolas Marty, Castelginest (FR); Philippe Salmon, Colomiers (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-seine (FR)

(21) Appl. No.: 11/912,243

(22) PCT Filed: Apr. 7, 2006
(86) PCT No.: PCT/EP2006/061426

§ 371 Date: Oct. 22, 2007

(30) Foreign Application Priority Data
Apr. 22, 2005 (FR) 05/04077

(51) Int. Cl. G08G 5/00

(52) U.S. Cl. 701/120

(57) ABSTRACT

The device attracts the attention of an aircraft crew on approach or normal (alert) or abnormal (alarm) crossing, of a traffic zone of an airport infrastructure presenting risks of collision. Accordingly, it selects on the basis of the information provided by the flight instruments, a type of flight phase from among a limited and pre-established choice of predefined types of flight phase. Then considers one or more runway incursion scenarios that are predefined as a function of the selected type of flight phase whose likelihood it analyzes by comparing the position of the aircraft provided by an onboard locating device with a plan of the airport infrastructure derived from an airport database and determines, on the basis of the analyzed scenarios that appear to be likely, alerts and alarms to be emitted in the cockpit.

### CROSS-REFERENCE TO RELATED APPLICATIONS

The present Application is based on International Application No. PCT/EP2006/061426, filed Apr. 7, 2006, which in turn corresponds to France Application No. 05 04077, filed on Apr. 22, 2005, and priority is hereby claimed under 35 USC §119 based on these applications. Each of these applications are hereby incorporated by reference in their entirety into the present application.

### FIELD OF THE INVENTION

The present invention relates to the prevention of collisions in an airport infrastructure, by alerts and alarms attracting the attention of an aircraft crew on the approach to or the normal (alert) or abnormal (alarm) crossing, in the course of a maneuver on the ground or in flight, of a traffic zone at risk of collision (takeoff or landing runway, runway access linkway, parking area, boarding gates access area, etc.).

### BACKGROUND OF THE INVENTION

Air traffic control authorities have at all times been concerned with the prevention of collisions on traffic areas in airport infrastructures. To address this concern, various automatic monitoring systems have been proposed, all based on the detection and location of craft (aircraft, service vehicles, personnel vehicles) parked or moving around traffic areas, with respect to a stored plan of the airport structure with its buildings and its traffic areas and the traffic restrictions associated with them.

The first monitoring systems employed one or more ground radars to locate craft and required large-size computers to utilize the radar signals, so that they were reserved for control tower personnel, the alerts and alarms being transmitted to the craft concerned by radio or by runway loudspeakers, either in an automatic manner, or by way of the control tower personnel who additionally keep a visual lookout.

With the appearance of satellite-based positioning systems allowing individual guidance of craft in a tangle of traffic lanes and the trends in computers, databases and digital transmission equipment towards a decrease in their size and an increase in their performance, automatic airport zone monitoring systems have migrated aboard craft.

One example among others, of an automatic system for monitoring the traffic on the traffic areas of an airport infrastructure that may have craft-borne terminals ensuring a complete collision risk detection and alert function is described in American patent U.S. Pat. No. 6,182,005 (columns 147, 148). These terminals are equipment which ensure guidance on the ground as a function of a pre-established path entirely analogous to the guidance of a vehicle or pedestrian carried out by a satellite-based positioning receiver after programming the destination point and possibly compulsory waypoints and which generate alerts and alarms only if disregard of their instructions results in a risk of crossing or the crossing of a protected zone listed on a stored plan of the airport infrastructure. They have the drawback of demanding programming of the path to be followed failing which, they generate false alarms which have the effect rathermore of distracting the pilot of the craft or the pedestrian than of ensuring his safety.

Another example of an automatic system for monitoring the traffic on the traffic areas of an airport infrastructure, operating with the aid of a satellite-based positioning system and a stored plan of the lanes and their traffic restrictions, with craft-borne terminals emitting alerts and alarms whenever the equipped craft approaches or crosses on the ground, a protected zone of an airport infrastructure is described in American patent U.S. Pat. No. 6,606,563. Here again, the problem arises of false alerts and alarms occuring when the equipped craft approaches or penetrates with good reason into a protected zone.

For an aircraft, the problem of false alerts and alarms when approaching or penetrating protected traffic zones is partially dealt with in the systems of the prior art by consideration of the fact that it is on the ground rolling or in flight. Despite this, false alerts and alarms remain a significant source of disturbances which limits the confidence accorded to these systems by crews.

### SUMMARY OF THE INVENTION

An object of the present invention is to generate alerts and alarms signaling to the crew of the aircraft moving in an airport zone, the risk traffic zones when they encounter one, with the fewest possible false alerts and alarms.

The present invention relates to a method of alerts and alarms for signaling the risk traffic zones in an airport infrastructure, to the crew of an aircraft provided with flight instruments advising on the flight phase which the aircraft is in, with a geographical locating device and with one or more emitters of audible or visual alerts or alarms, said method comprising the following successive steps:

selecting, on the basis of the information provided by the flight instruments and, possibly, by ground collision prevention equipment, a type of flight phase from among a limited and pre-established choice of predefined types of flight phase,

selecting on the basis of the flight phase type adopted, one or more runway incursion scenarios from among a predefined set of types of runway incursion scenarios,

analyzing the likelihood of the runway incursion scenario or scenarios adopted on the basis of the location of the aircraft provided by the locating device, with respect to the airport structures listed in an airport database, and

determining on the basis of the runway incursion scenarios considered to be likely, the alerts and alarms to be emitted by the alerts and alarms emitters.

The invention further relates to a device, carried aboard an aircraft provided with flight instruments providing flight information and with a geographical locating device, generating alerts and alarms signaling risk traffic zones in an airport infrastructure and comprising:

an airports cartographic databank, holding a plan of the airport infrastructure and the associated traffic restrictions,

an emitter of audible or visual alerts or alarms, and

a computer locating the aircraft in the airport infrastructure stored in the airport databank on the basis of position information delivered by the locating device, analyzing the risks of runway incursion related to the position of the aircraft and, possibly to its motion, and, in the event of detecting a risk or a runway intrusion, determining the appropriate alert or alarm and triggering its emission by the alerts and alarms emitter.

This device is noteworthy in that its computer analyzes the risks of runway incursion by searching for whether the current position of the aircraft and possibly its motion meets a limited number of specific and predefined situations of runway incursion or risk of runway incursion within the broad sense, termed scenarios, chosen as a function of a flight phase type selected from among a limited and pre-established choice of predefined types of flight phase, on the basis of flight information provided by the flight instruments of the aircraft.

Advantageously, the predefined types of flight phase taken into account are:

landing,

movement on the ground, while rolling, between a parking area and a takeoff or landing runway,

the part of the takeoff where the aircraft rolls on the runway while accelerating until it reaches the liftoff speed.

Advantageously, the runway incursion or risk of runway incursion scenarios taken into account are:

rolling entry to the start of a runway,

rolling entry to the end of a runway with a view to a takeoff against the runway,

rolling entry to a runway, at an intermediate level,

rolling approach to a start of a runway,

rolling approach to the intermediate part of a runway,

rolling approach to a runway intersection,

rolling approach to an end of a runway,

rolling approach to a boarding gate,

too high a rolling speed (attempted takeoff outside of a runway).

Advantageously, for the predefined type of flight phase corresponding to landing, the scenarios taken into account are the rolling approach to a runway intersection and the rolling approach to an end of a runway.

Advantageously, for the predefined type of flight phase corresponding to the part of the takeoff where the aircraft rolls on the runway while accelerating until it reaches the liftoff speed, the scenarios taken into account are the rolling approach to a runway intersection and the rolling approach to an end of a runway.

Advantageously, for the predefined type of flight phase corresponding to a rolling movement, between a parking area and a takeoff or landing runway, the scenarios taken into account are:

rolling entry to the start of a runway,

rolling entry to the end of a runway with a view to a takeoff against the runway,

rolling entry, to a runway, at an intermediate level,

rolling approach to a start of a runway,

rolling approach to an intermediate runway part,

rolling approach to a runway intersection,

rolling approach to a boarding gate, and

too high a rolling speed.

Advantageously, when no predefined type of flight phase is recognized, the device takes account of no scenario and does not emit any alert or alarm.

Advantageously, the device considers that the aircraft is on a runway when the component D_{RWY} normal to the axis of the runway considered, of a vector joining the aircraft to the start of the runway considered, component termed axial distance of the aircraft with respect to the runway considered, is lower, in modulus, than the sum of a position error margin EPE allowed for the locating device, of the longitudinal distance ALR separating the front end of the aircraft from the airplane reference point used for its measurements, by the locating device, and of half the width of the runway RW_{RWY} considered, and when the component L_{RWY} parallel to the axis of the runway considered of the same vector, component termed longitudinal distance of the aircraft with respect to the runway considered, lies between the opposite of the error margin −EPE and the sum of the position error margin EPE and of the runway length RL_{RWY}:

|D_{RWY}|<EPE+ALR+0.5RW_{RWY}

and

−EPE<L_{RWY}<EPE+RL_{RWY}

Advantageously, the device allies the predefined type of flight phase corresponding to the part of the takeoff where the aircraft rolls on the runway while accelerating until it reaches the liftoff speed to the fact that the information originating from the flight instruments of the aircraft indicates:

that the aircraft is on the ground,

that its ground speed is greater than a speed maximum permitted for a rolling path between a parking area and a landing or takeoff runway,

that it is accelerating,

that its flaps are extended

and when a first analysis of the location and heading of the aircraft with respect to the airport infrastructure shows:

that the aircraft is on a runway, and

that its heading corresponds to that of the runway where it is situated.

Advantageously, the device allies the predefined type of flight phase corresponding to a landing to the fact that the information originating from the flight instruments of the aircraft indicates:

that it is on the ground,

that its speed is greater than a speed maximum permitted for a path between a parking area and a landing or takeoff runway,

that it is decelerating,

and when a first analysis of the location and heading of the aircraft with respect to the airport infrastructure shows that:

that the aircraft is on a runway, and

that its heading corresponds to that of the runway where it is situated,

Advantageously, the device allies the predefined type of flight phase corresponding to a movement on the ground, while rolling, between a parking area and a takeoff or landing runway to the fact that the information originating from the flight instruments of the aircraft indicates:

that it is on the ground, and

that its speed is less than a speed maximum permitted for a path between a parking area and a landing or takeoff runway.

Advantageously, the device detects a scenario of rolling incursion onto a start of a runway, when the axial distance, taken as absolute value, |D_{RWY}| of the aircraft with respect to one of the runways of the airport infrastructure is less than the sum of:

the position error margin EPE of the geographical locating device of the aircraft,

of the maximum of the distance ALR separating the front end of the aircraft from the airplane reference point used for its measurements by the geographical locating device of the aircraft and of the wingspan AWS of the aircraft,

of half the width of the runway RW considered

and when the longitudinal distance, in absolute value, |L_{RWY}| of the aircraft with respect to this same runway, is less than the sum of the error margin EPE and of the distance ALR longitudinally separating the front end of the aircraft from the airplane reference point used for its measurements by the geographical locating device.

|D_{RWY}|<EPE+Max(ALR, AWS)+0.5RW

and

|L_{RWY}|<EPE+ARL

Advantageously, the device detects a scenario of rolling incursion onto an end of a runway with a bad takeoff orientation, when the previous conditions of the rolling scenario on a start of a runway are complied with

|D_{RWY}|<EPE+ALR+0.5RW

and

|L_{RWY}|<EPE+ARL

and when that the heading delivered by the flight instruments of the aircraft differs by more than 120 degrees from that of the runway considered.

Advantageously, the device detects a scenario of rolling incursion onto the intermediate part of a runway when the axial distance, taken as absolute value, |D_{RWY}| of the aircraft with respect to a runway of the airport infrastructure, is less than the sum of:

the position error margin EPE of the geographical locating device of the aircraft,

of the distance ALR separating the front end of the aircraft from the airplane reference point used for its measurements by the locating device, and

of half the width of the runway RW_{RWY} considered and when the longitudinal distance L_{RWY} of the aircraft with respect to the runway considered lies between the opposite −EPE of the error margin of the locating device and the sum of the position error margin EPE and of the runway length RL_{RWY:}

|D_{RWY}|<EPE+ALR+0.5RW_{RWY}

and

−EPE<L_{RWY}<EPE+RL_{RWY}

Advantageously, the device detects a scenario of risk of runway incursion by rolling approach to a runway entry, when the axial distance D_{RWY} and the longitudinal distance L_{RWY} of the aircraft with respect to a runway satisfy the inequalities:

|D_{RWY}|<EPE+Max(RTD/2; ARD×GS_{XE})+ALR+0.5RW_{RWY}

and

|L_{RWY}|<EPE+Max(RPL/2; ARD×GS_{XR})

in which:
RDT is a default value of a spacing distance between the runway and an access linkway running alongside it,
ADT is a lag defined by the relation:

ARD=Max(RTD;RPL)/TSL+ARM

RPL being an exterior protection distance for the runway,

TSL being an upper limit of permitted rolling speed, and

ARM a reaction lag allowed to the crew of the aircraft,
GS_{XE} is the aircraft's rolling speed component perpendicular to the axis of the runway, and
GS_{XR} is the aircraft's rolling speed component parallel to the axis of the runway.

Advantageously, the device detects a scenario of risk of runway incursion by rolling approach to an intermediate part of a runway, when the axial distance D_{RWY} and the axial distance L_{RWY} of the aircraft with respect to a runway satisfy the inequalities:

|D_{RWY}|<EPE+Max(RTD/2; AID×GS_{XE})+ALR+0.5RW

and

−EPE<L_{RWY}<RL

in which:
AID is a lag defined by the relation:

AID=RTD/TSL+AIM

AIM being a reaction lag allowed to the crew of the aircraft.

Advantageously, the device detects a scenario of risk of runway incursion by rolling approach to a runway intersection when the distance D_{IN} of the aircraft with respect to a runway intersection satisfies the inequalities:

|D_{RWY}|<EPE+ALR+0.5RW

and

−EPE<L_{RWY}<EPE+RL

and

D_{IN}<GS×RID
GS being the rolling speed of the aircraft, and
RID a reaction lag allowed to the crew of the aircraft.

Advantageously, the device detects a scenario of risk of runway incursion by rolling approach to an end of a runway by applying:
a first criterion of runway presence signifying that the aircraft is on a runway consists of the following conditions:

|D_{RWY}|<EPE+0.5RW

and

EPE<L_{RWY}<EPE+RL
a second criterion of runway travel consisting in adopting from among the runways satisfying the runway presence criterion only that whose orientation is the nearest to the true heading of the aircraft, the true heading and the orientation of the selected runway having not to differ by more than ±60 degrees, and
an alternation of two criteria:
   either an insufficient deceleration criterion consisting in the satisfaction of the set of conditions:

GS>133% TSL

μ<0

d_{B}>|L_{RWY}−EPE|
μ being the ground rolling acceleration of the aircraft, and
dB a braking distance obeying the defining relation:

$${d}_{B} = \frac{1}{2 μ} [ {TSL}^{2} - {GS}^{2} ] + {M}_{B}$$

the senses of the speeds being counted negatively due to the fact that the runway vector is oriented in reverse to what is customary with the runway end as origin,
M_{B} being a braking distance margin corresponding to the distance which is estimated necessary for the aircraft to stop when it rolls at the maximum permitted rolling speed TSL.
or a runway rolling criterion consisting of two sets of conditions at least one of which must be satisfied,
   a first set of conditions signifying that the aircraft is at a distance from the end of a runway that is less than the braking margin M_{B}:

GS<133% TSL

|L_{RWY}|<EPE+M_{B}

or
a second set of conditions signifying that the aircraft is rolling while accelerating although close to the end of a runway:

GS<133% TSL

|L_{RWY}|<EPE+2M_{B}

Advantageously, the device detects a scenario of risk of runway incursion by rolling approach to a boarding gate by applying two criteria:

a first criterion signifying that the aircraft is not on a runway area of the airport infrastructure, consists of the set of conditions one of which must not be complied with:

L_{RWY}<RL+RPL

or

L_{RWY}<−RPL

or

|D_{RWY}|<RTD

RPL being a length protection margin for the runway considered,

a second criterion signifying that the aircraft is within range of the boarding gates without having drawn alongside them, consists of the condition:

DG_{ARP}<500 m

DG_{ARP} being the distance from the aircraft to any one of the boarding gates.

Advantageously, when the device has detected a scenario of risk of runway incursion by rolling approach to a boarding gate, it signals the orientation of the nearest boarding gate by determining in which angular sector of the headings rose of the aircraft it is situated.

Advantageously, the device detects a scenario of risk of runway incursion by attempted takeoff outside of a runway by applying two criteria:
a criterion signifying that the aircraft is preparing for takeoff:
   engine speed information corresponding to takeoff given by the flight instruments, and
   flaps extended information given by the flight instruments, and
a criterion signifying that the aircraft is not on a runway, consisting of the set of conditions one of which must not be complied with:

L_{RWY}<RL+RPL

or

L_{RWY}<−RPL

or

|D_{RWY}|<RTD

RPL being a length protection margin for the runway considered,

Advantageously, the device comprises an alert or alarm generator delivering alerts and alarms suited to the various runway incursion or risk of incursion scenarios, associated with priority levels making it possible, upon the simultaneous detection of several incursion or risk of incursion scenarios meriting several alarms, to have the alarm emitters emit only the most significant alert or alarm.

### BRIEF DESCRIPTION OF THE DRAWINGS

Other characteristics and advantages of the invention will emerge from the description hereinafter, of an embodiment given by way of example. This description will be offered in relation to the drawing in which:

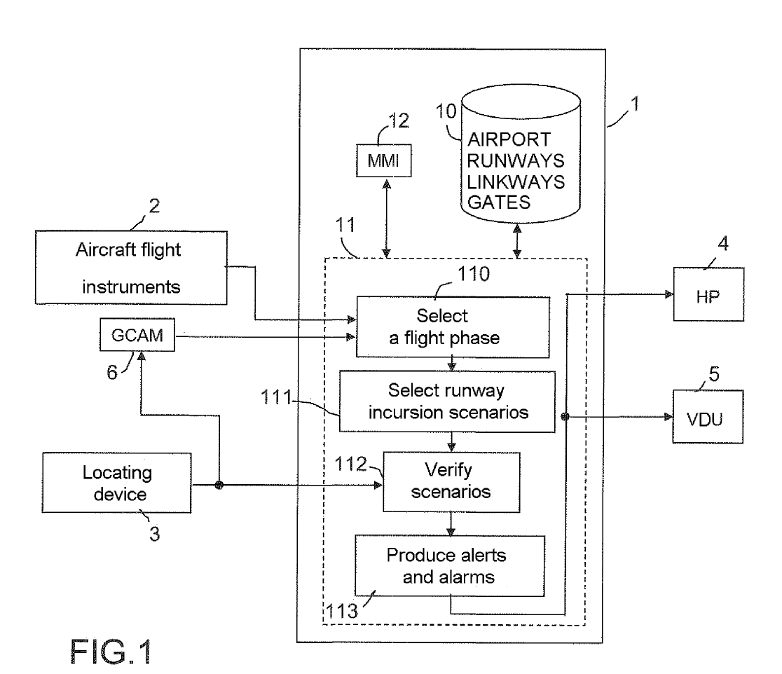

a FIG. 1 is an exemplary diagram of an onboard device for a runway incursion alert according to the invention,

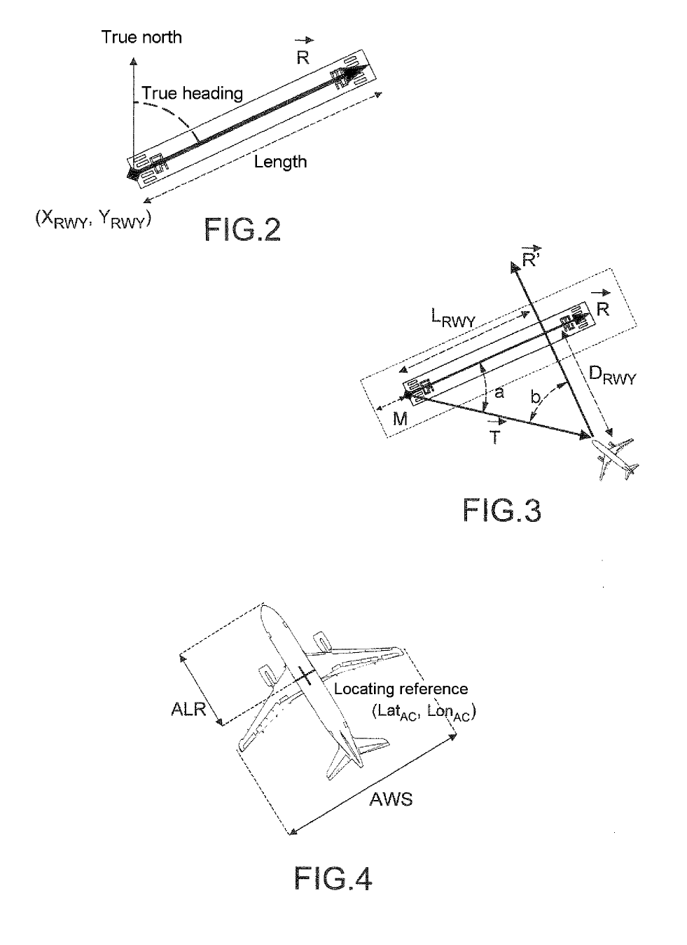

a FIG. 2 is a diagram giving an exemplary marking of a runway in an airports topographic database,

a FIG. 3 is a diagram illustrating a runway-aircraft distance calculation,

a FIG. 4 is a diagram illustrating the distances taken into consideration for measuring the footprint of an aircraft as well as the location of the airplane reference point,

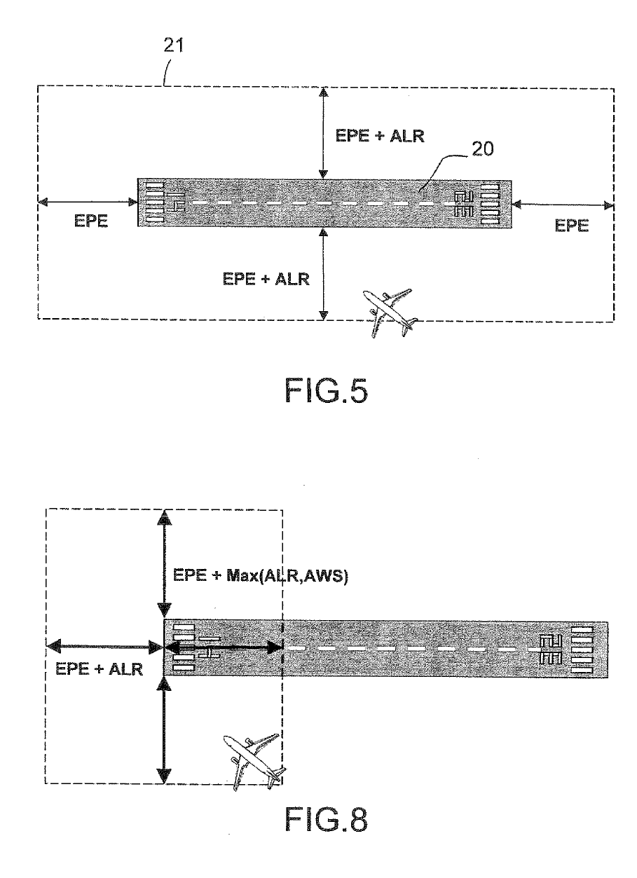

a FIG. 5 is a diagram illustrating the concept of presence on runway for an aircraft,

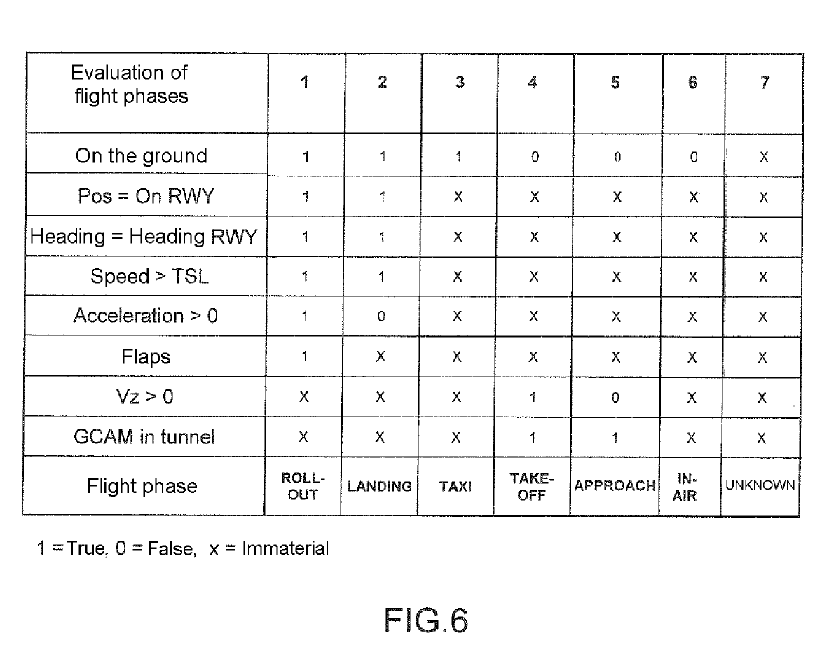

a FIG. 6 is a table summarizing the criteria underlying the selection of a predefined flight phase,

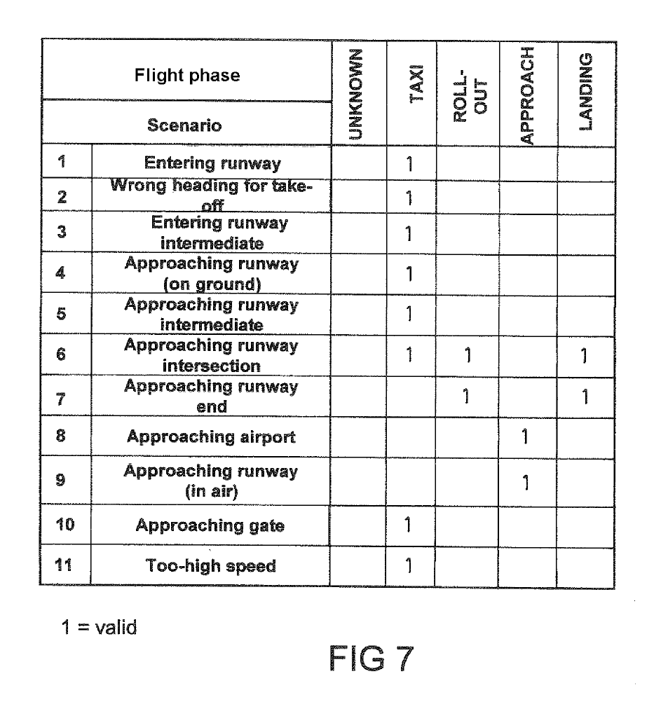

a FIG. 7 is a table summarizing the predefined runway incursion scenarios associated with each predefined flight phase,

a FIG. 8 is a diagram illustrating the concept of presence at the start of a runway for an aircraft,

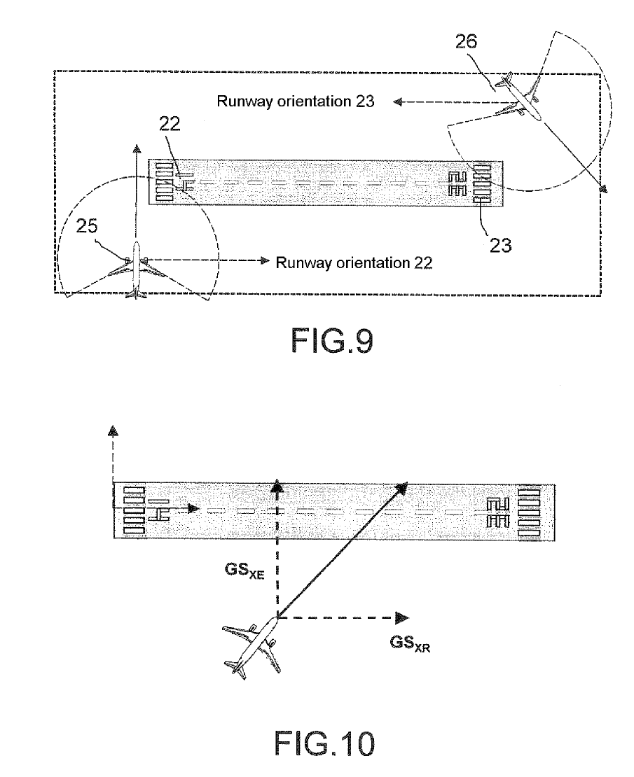

a FIG. 9 is a diagram illustrating a runway end rolling incursion scenario,

a FIG. 10 is a diagram illustrating the concepts of longitudinal speed component and component perpendicular to a runway,

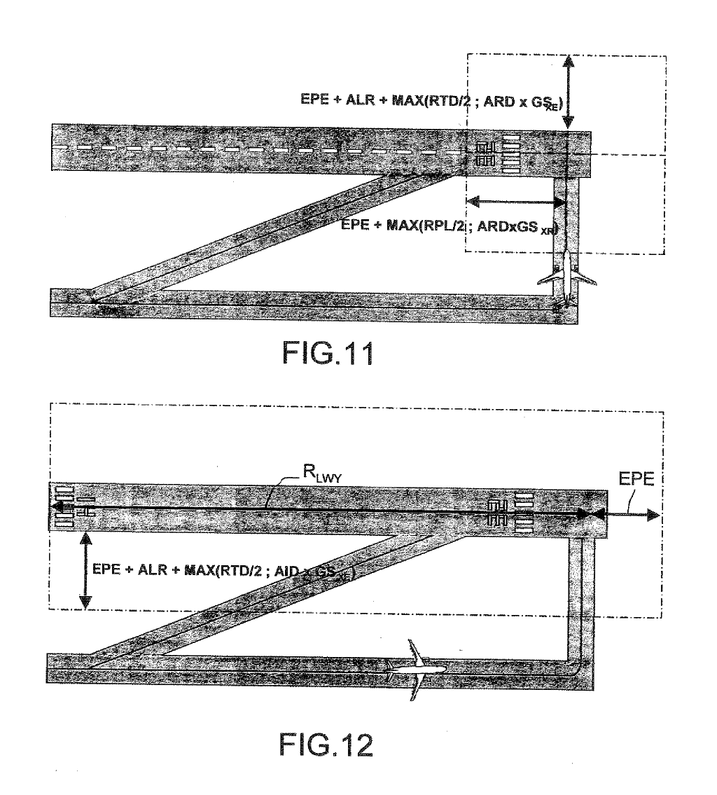

a FIG. 11 is a diagram illustrating a scenario of rolling approach to a start of a runway,

a FIG. 12 is a diagram illustrating a scenario of rolling approach to an intermediate part of a runway,

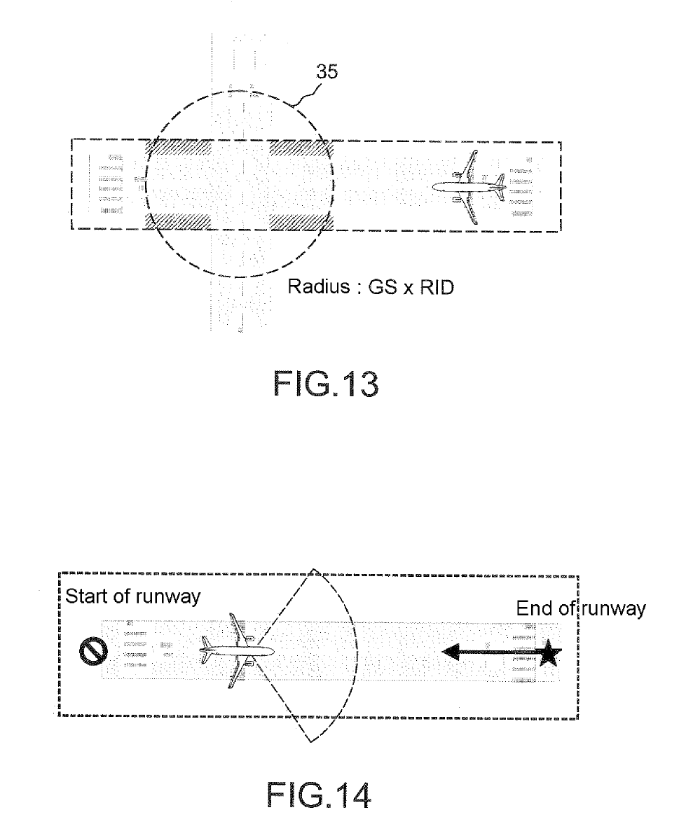

a FIG. 13 is a diagram illustrating a scenario of rolling approach to a runway intersection,

a FIG. 14 is a diagram illustrating a scenario of rolling approach to an end of a runway,

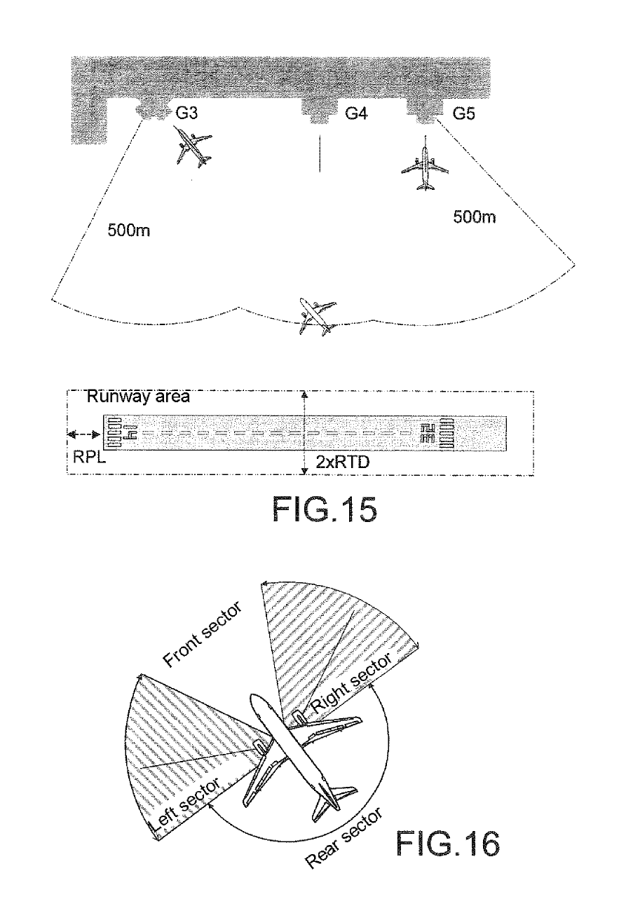

a FIG. 15 is a diagram illustrating a scenario of rolling approach to passenger boarding gates,

a FIG. 16 is a diagram illustrating the concept of angular sectors sliced from an aircraft's headings rose,

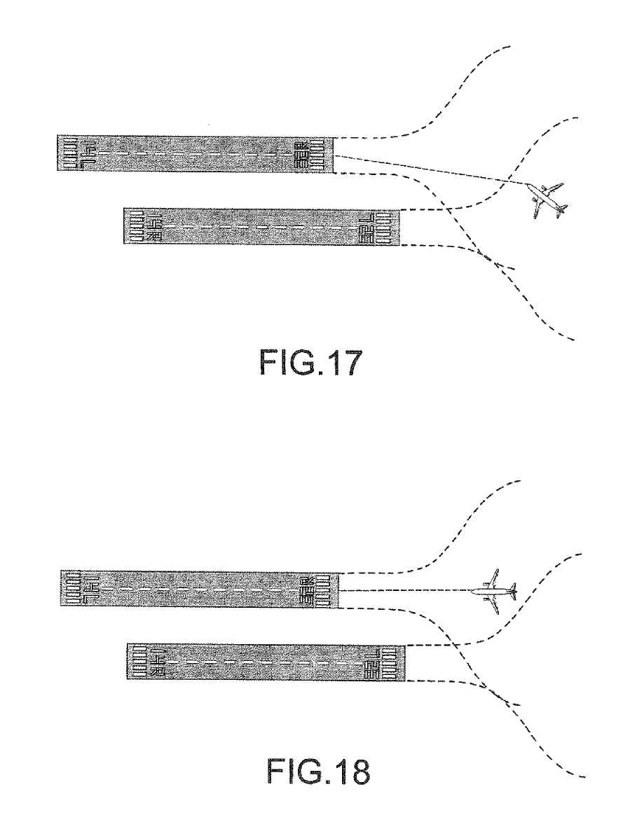

a FIG. 17 is a diagram illustrating a scenario of air approach to an airport,

a FIG. 18 is a diagram illustrating a scenario of air approach to an airport runway, and

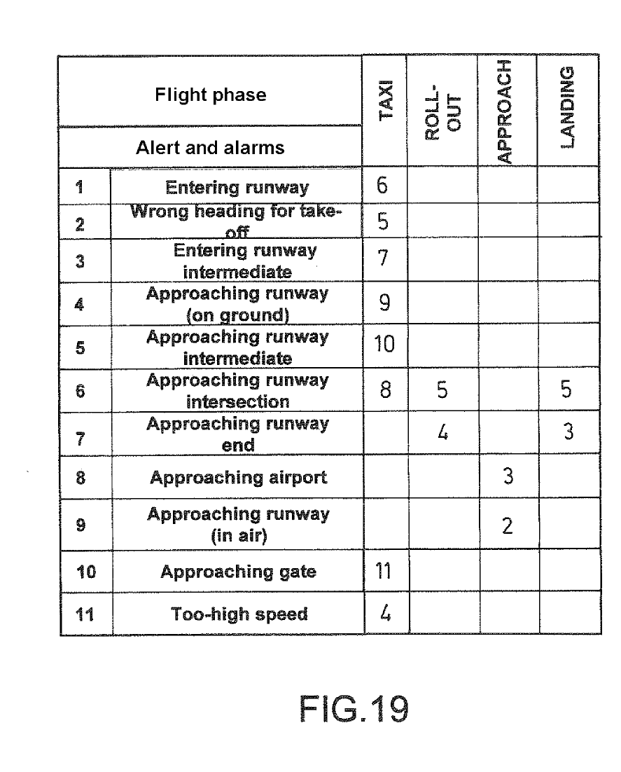

a FIG. 19 is a table summarizing the priorities of the various alerts and alarms generated by a runway incursion alerts and alarms device according to the invention.

### DETAILED DESCRIPTION OF PREFERRED EMBODIMENT

As shown in FIG. 1, the onboard runway incursion alert or alarm device 1 is inserted into the onboard equipment of a the aircraft between the flight instruments 2 delivering information on the flight conditions, a locating device 3, for example a receiver of a GNSS satellite-based positioning system (the acronym standing for the expression: “Global Navigation Satellite System”) such as GPS (the acronym standing for the expression “Global Positioning System”) being usable additionally by a flight management computer, not represented, and alerts and alarms emitters placed in the cockpit, either of audible or voice type 4: loudspeaker, siren, buzzer, etc., or of visual type 5: indicator light, risk map display screen, etc. It mainly comprises:

a database 10 holding information on the topology of the airports frequented by the aircraft,

a computer 11 utilizing the information originating from the flight instruments 2, the locating device 3 and the airport database 10 to produce alerts and alarms relayed to the cockpit by the alerts and alarms emitters 4, 5, and

a man-machine interface MMI 12, for example an MCDU (acronym originating from the expression: “Multipurpose Control Display Unit”) allowing parametrization by a member of the crew of the aircraft or of a maintenance team.

FIG. 1 moreover depicts a GCAM equipment 6 (acronym derived from the expression: “Ground Collision Awareness Module”) also known as TAWS (acronym derived from the expression: “Terrain Awareness Warning System”). This GCAM equipment ensures a function of preventing collisions with the ground when the aircraft is in flight. It situates the aircraft with respect to the region overflown by virtue of the position information delivered by the locating device 3 and a map of the terrain overflown extracted from a cartographic database, and takes care that the aircraft always has an escapehole at its disposal when its medium or short term forecastable trajectory impacts the ground. This GCAM equipment 6, which is optional, is here assumed to furthermore ensure monitoring of the in-flight trajectory of the aircraft on the approach to an airport, either for a landing, or for a takeoff, this monitoring consisting, during a landing or a takeoff, in signaling to the crew, by alerts or alarms in the cockpit, a deviation of the aircraft with respect to a single or multiple virtual tunnel containing the permitted trajectories for accessing the runways of an airport or leaving them. It is mentioned here, since the example described of a runway incursion alert or alarm device 1 is used subsidiarilly to generate alerts or alarms which are specific to it while being much like the runway incursion alerts or alarms such as an airport proximity alert or a airport runway proximity alert and which relate to the aircraft while it is the air and not down and rolling.

The airport database 10 of the runway incursion alerts and alarms device 1 is a topographic database enclosing, for various airports, the plan of the airport structure, with its landing and takeoff runways, the various access linkways to the runways, the service lanes, the aircraft parking areas, the passenger boarding gate access areas, the passenger boarding gates, the constructions and installations to be circumvented, etc., each associated with their own traffic restrictions.

The computer 11 is configured to implement a method for generating alerts and alarms and comprising the following successive steps:

selecting, at 110, on the basis of the information provided by the flight instruments 2, the locating device 3, the airport database 10 and, possibly, when it is present, by the GCAM equipment 6, a flight phase from among a pre-established limited choice of flight phases,

selecting, at 111, on the basis of the flight phase adopted, one or more types of runway incursion scenarios from among a predefined set of types of runway incursion scenarios,

analyzing, at 112, the likelihood of the types of runway incursion scenarios adopted as a function of the location of the aircraft with respect to the airport structures listed in the airport database 10, and

producing, at 113, the alerts and alarms associated with the types of runway incursion scenarios considered to be likely destined for the alerts and alarms emitters 4, 5.

The predefined types of flight phase taken into consideration in respect of the alerts and alarms related to runway incursions are:

landing,

movement on the ground, while rolling, between a parking area and a takeoff or landing runway (“Taxi”),

the part of the takeoff where the aircraft rolls on the runway while accelerating until it reaches the liftoff speed (“Roll out”).

To these types of flight phase related to the possibilities of runway incursions within the broad sense, that is to say generating risks of collision for an aircraft when rolling, with another aircraft, a runway vehicle or a construction, etc. is added, because of the presence of a GCAM equipment 6, the landing approach while the aircraft is in the air.

The selection of a type of flight phase is based on several items of information originating from the flight instruments 2 and, possibly on first analyses of the location and heading of the aircraft with respect to the airport runways.

The information originating from the onboard instruments which is taken into account in selecting a flight phase is:

information on the position on the ground, or in the air of the aircraft, derived either from the load supported by the landing gear of the aircraft (hydraulic pressure of the shock absorbers of the landing gear) or from comparing the altitude of the aircraft provided by an altimeter, a radio-altimeter or by the locating device with the altitude of the runways of the airport considered,

information as to whether or not ground speed is greater than the permitted rolling speed,

the sign of the acceleration of the ground motion of the aircraft,

the position of the flaps of the aircraft, and

the sign of the vertical speed of the aircraft.

The term runway is taken here in its usual aeronautical acceptation, that is to say designating a strip of land laid out for landings and takeoffs and associated with a direction of travel. Thus, two different runways within the aeronautical sense, can share the same strip of land laid out but with opposite directions of travel. The airport database 10 lists, for each airport, the set of runways usable for takeoff and landing. Hereinafter, a runway is identified, as shown in FIG. 2, by a vector \vec{R} whose origin is a start of a runway and whose tip is an end of a runway, and which is listed in the airport database 10, by the coordinates (x_{RWY}, y_{RWY}) of the start of the runway, by the orientation of the runway having regard to its direction (“true heading”) and by the length of the runway.

The locating device 2, like the airport database 10 use, at the level of an airport, one and the same local geographical reference frame. The latter is situated at the point ARP corresponding to the longitude Lon_{ARP} and the latitude lat_{ARP} assigned to the airport considered in the WGS84 (“World Geodetic System”) marking system used by the GPS system. It is of direct type, with its abscissa axis oriented parallel to the longitude direction and its ordinate axis oriented to true North, parallel to the latitude direction. The calculation of the distances is done with a locally flat earth assumption. Thus, a point A with longitude Lon_{A} and latitude Lat_{A}, has coordinates xₐ, yₐ in the local geographical frame of the airport:

$${A}_{( WGS 84 )} ( \begin{matrix}{Lon}_{A} \\ {Lat}_{A}\end{matrix} ) ⇒ {A}_{( {REF}_{ARP} , x , y )} ( \begin{matrix}{x}_{A} = 1852 \times 60 \times ( {Lon}_{A} - {Lon}_{ARP} ) \times cos ( {Lat}_{ARP} ) \\ {y}_{A} = 1852 \times 60 \times ( {Lat}_{A} - {Lat}_{ARP} )\end{matrix} )$$

The Euclidean distance d(A,B) separating this point A from another point B with longitude Lon_{B} and Latitude Lat_{B}, is given by the relation:

$$d ( A , B ) = 1852 \times 60 \times \sqrt{{( {Lat}_{B} - {Lat}_{A} )}^{2} + [ ( {Lon}_{B} - {Lon}_{A} ) \times {cos ( {Lat}_{ARP} )}^{2} ]}$$

The aim of the first analysis for locating the aircraft with respect to the airport runways is to determine whether or not the aircraft is present on a runway. It relies, like the following locating analyses, on a study of the axial components D_{RWY}, oriented at +π/2 to the axes of the runways, and of the longitudinal components L_{RWY} oriented parallel to the axes of the runways, of the vectors connecting the starts or entrys of the runways to the position of the aircraft.

The axial D_{RWY} and longitudinal L_{RWY} components of the vector connecting the entry of a runway RWY to the position of the aircraft, can, as shown in FIG. 3, be deduced from the components x_{T}, y_{T} of the vector \vec{T} connecting the entry M of the runway RWY to the position of the aircraft and the components x_{R}, y_{R} of the runway vector \vec{R}. Specifically, if the vectors \vec{T} and \vec{R} are supplemented with the vector \vec{R}′ deduced from the vector \vec{R} by a rotation of π/2 and having the position of the aircraft as origin, it follows that:

$$\vec{T} ( \begin{matrix}{x}_{T} \\ {y}_{T}\end{matrix} ) ; \vec{R} ( \begin{matrix}{x}_{R} \\ {y}_{R}\end{matrix} ) ; {\vec{R}}^{′} ( \begin{matrix}- {y}_{R} \\ {x}_{R}\end{matrix} )$$

$$with \text{:}$$

$$\vec{T} \cdot \vec{R} = T \cdot R \cdot cos ( a )$$

$$and$$

$$cos ( a ) = \frac{{L}_{RWY}}{T}$$

$$a being the oriented angle ( \vec{R} , \vec{T} ) \\ - \vec{T} \cdot \vec{R} = T \cdot R \cdot cos ( b )$$

$$and$$

$$cos ( b ) = \frac{{D}_{RWY}}{T}$$

$$b being the oriented angle ( {\vec{R}}^{′} , \vec{T} )$$

$$so that \text{:}$$

$${L}_{RWY} = \frac{{x}_{T} {x}_{R} + {y}_{T} {y}_{R}}{R}$$

$$and$$

$${D}_{RWY} = \frac{- {x}_{T} {y}_{R} + {y}_{T} {x}_{R}}{R}$$

Knowing that the components x_{T} and y_{T} of the vector \vec{T} are deduced from the coordinates X_{RWY} and y_{RWY} of its origin, derived from the airport database 10 and from the coordinates of its tip, provided by the locating device, these relations make it possible to estimate the axial D_{RWY} and longitudinal L_{RWY} oriented distances of the aircraft with respect to a runway RWY.

In addition to the axial D_{RWY} and longitudinal L_{RWY} components of the distance vector separating a runway entry, from the aircraft, the first analysis for locating the aircraft with respect to the airport runways, like the following locating analyses take into account the footprint of the aircraft which is estimated, as shown by FIG. 4, by means of the longitudinal distance ALR which separates the front end of the aircraft, from the airplane reference point used for its measurements, by the locating device 3 and the wingspan AWS of the aircraft.

The first analysis for locating the aircraft with respect to the airport runways for determining whether or not the aircraft is on a runway consists in searching for whether, from among the listed runways of the airport, each strip of land laid out as runway that may appear twice in the airport database 10, under two different identities as a function of the end considered to be the start of a runway, there exists at least one satisfying the following runway presence criterion:

|D_{RWY}|<EPE+ALR+0.5×RW_{RWY}

and

−EPE<L_{RWY}<EPE +RL_{RWY}

EPE being a position error margin allowed for the locating device 3, and RW_{RWY} being the width of the runway RWY considered, and RL_{RWY} being the length of the runway considered.

Satisfaction of this runway presence criterion makes it possible to be sure, as shown by FIG. 5, that the aircraft is inside an area consisting of that 20 of a runway surrounded by a boundary 21 taking into account the position error margin EPE of the locating device 3 and the footprint of the aircraft estimated here by the longitudinal distance ALR since the aircraft is not assumed to run alongside the runway but possibly to join it at an intermediate level. Hereinafter, a logical flag “On RWY” is associated for each runway RWY with the runway presence criterion. This flag takes a value 1 when the criterion is satisfied and 0 when it is not.

If in addition to the runway presence criterion satisfied for a runway RWY (On RWY=1), the heading of the aircraft turns out to be plus or minus 60 degrees from the direction of this runway RWY, the aircraft is assumed to be in a flight phase corresponding to rolling, either on takeoff, or on landing.

More precisely, a predefined flight phase “Roll-Out” corresponding to the part of the takeoff where the aircraft rolls on the runway while accelerating until it reaches the liftoff speed is selected when the information originating from the flight instruments 2 of the aircraft indicates:

that the aircraft is on the ground (landing gear extended and loaded or altitude corresponding to that of the airport),

that its ground speed is greater than a speed maximum permitted for a rolling path between a parking area and a landing or takeoff runway,

that it is accelerating,

that its flaps are extended,

and when a first analysis of the location and heading of the aircraft with respect to the airport infrastructure shows:

that the aircraft is on a runway (On RWY=1) for one of the runways, and

that its heading corresponds to that of the runway where it is situated,

A predefined flight phase “Landing” corresponding to a landing is selected when the information originating from the flight instruments 2 indicates:

that the aircraft is on the ground (landing gear extended and loaded or altitude of the aircraft less than or equal to those of the runways of the airport considered),

that its speed is greater than a speed maximum permitted for a rolling path between a parking area and a landing or takeoff runway, and

that it is decelerating,

and when a first analysis of the location and heading of the aircraft with respect to the airport infrastructure shows:

that the aircraft is on a runway (On RWY=1), and

that its heading corresponds to that of the runway where it is situated.

A predefined flight phase “Taxi” corresponding to a movement on the ground, while rolling, between a parking area and a takeoff or landing runway is selected when the information originating from the flight instruments 2 indicates:

that the aircraft is on the ground (landing gear extended and loaded or altitude of the aircraft less than or equal to those of the runways of the airport considered), and

that its speed is less than a speed maximum permitted for a path between a parking area and a landing or takeoff runway.

A predefined flight phase “take-Off” corresponding to an end of takeoff, the aircraft being in the air, is selected when the flight instruments 2 indicate that:

that the aircraft is in the air (landing gear unloaded or altitude of the aircraft greater than those of the runways of the airport considered), and

that the vertical speed of the aircraft is positive, and when the GCAM equipment 6 indicates that it is in virtual tunnel monitoring phase.

A predefined flight phase “Approach” corresponding to an impending landing, the aircraft being in the air, is selected when the flight instruments 2 indicate that:

that the aircraft is in the air (landing gear unloaded or altitude of the aircraft greater than those of the runways of the airport considered), and

that the vertical speed of the aircraft is negative, and when the GCAM equipment 6 indicates that it is in virtual tunnel monitoring phase.

Finally, a predefined flight phase termed “unrecognized” is selected by default, in the case where none of the previous predefined flight phases could be recognized.

The set of criteria for selecting the predefined flight phases is summarized in the table of FIG. 6

The runway incursion or risk of runway incursion scenarios taken into consideration are:

rolling entry to a start of a runway (“Entering Runway”),

rolling entry to an end of a runway with the intention of a takeoff against the runway (“Wrong Heading for Take-off”),

rolling entry to a runway, at an intermediate level, (“Entering Runway Intermediate”),

rolling approach to a start of a runway (“Approaching Runway”),

rolling approach to the intermediate part of a runway (“Approaching Runway Intermediate”),

rolling approach to a runway intersection (“Approaching Runway Intersection”),

rolling approach to an end of a runway (“Approaching Runway End”),

rolling approach to a boarding gate (“Approaching Gate”),

too high a rolling speed possibly corresponding to a takeoff attempt outside of a runway (“Too-High Speed”).

To these runway incursion scenarios are added two allied scenarios, specific to the GCAM equipment 6 justifying consideration of the “Take-Off” and “Approach” predefined flight phases, and leading to the emission of an airport proximity or runway proximity alert while the aircraft is in flight, on the approach to a landing.

For the predefined type of flight phase corresponding to a Landing, the scenarios taken into account are the approach to a runway intersection while rolling on the ground and the approach to an end of a runway while rolling on the ground. For the predefined type of flight phase corresponding to the part of the takeoff where the aircraft rolls on the runway while accelerating until it reaches the liftoff speed (“Roll-Out”), the scenarios taken into account are the approach to a runway intersection while rolling on the ground and the approach to an end of a runway while rolling on the ground. For the predefined type of flight phase corresponding to a movement on the ground, while rolling, between a parking area and a takeoff or landing runway (“Taxi”), the scenarios taken into account are:

entry while rolling on the ground to a start of a runway,

entry while rolling on the ground to an end of a runway with a view to a takeoff,

entry while rolling on the ground to a runway, at an intermediate level,

approach to a start of a runway while rolling on the ground,

approach to the intermediate part of a runway while rolling on the ground,

approach to a runway intersection while rolling on the ground,

approach to a boarding gate while rolling on the ground, and

too high a ground rolling speed.

When no type of predefined flight phase is recognized, the device takes account of no scenario and does not emit any alert or alarm

The various runway incursion scenarios taken into account as a function of each predefined type of flight phase are summarized in the table of FIG. 7.

The consideration of an incursion scenario, while rolling, at the start of a runway (“Entering Runway”), consists in comparing the aircraft's position given by the locating device 3 with those of the entries of the various runways of the infrastructure of the airport where the aircraft is presumed to be moving on the ground, as derived from the airport databank 10, by verifying whether there exists at least one runway RWY satisfying the runway entry occupancy criterion:

|D_{RWY}|<EPE+Max(ALR,AWS)+0.5RW

|L_{RWY}|<EPE+ARL

Satisfaction of this runway entry occupancy criterion makes it possible to be sure, as shown by FIG. 8, that the aircraft is inside a rectangular area centered on the start of a runway and of length, on the runway axis, twice the sum of the uncertainty margin EPE of the locating device 3 and of the longitudinal offset ALR of the aircraft, and of width, perpendicular to the axis of the runway, twice the sum of the uncertainty margin EPE of the locating device 3 and of the maximum of the longitudinal offset ALR or of the wingspan AWS of the aircraft. The dimensions of this area are suited to the fact that the aircraft can arrive laterally at the runway entry from a wide gamut of directions.

A check of this runway entry occupancy criterion confirms the likelihood of an incursion onto a start of a runway and leads to the emission, in the cockpit, after a confirmation lag, for example one second, of an runway entry alarm (“entering runway”) by the alarm emitters 4, 5. This alarm is repeated periodically for example, every second, so long as one of the following conditions is not fulfilled:

|L_{RWY}|>RPL/2

or

|D_{RWY}|>RTD/2

or

GS<33%×TSL

or

GS>133%×TSL
RPL being a default value, of exterior protection distance for the runway in its lengthwise direction,
RTD being a default value, of a minimum protection spacing between a runway and an access linkway running alongside it,
GS being the rolling speed on the ground,
TSL being the maximum rolling speed permitted outside of a takeoff or landing.
The satisfaction of one of the first two conditions shows that the aircraft has left the vicinity of the runway. That of the third condition shows that the aircraft is rolling and that of the fourth condition shows that the aircraft is taking off.

Once one of these conditions has been fulfilled, the runway entry incursion alarm is provisionally rescinded and then definitively rescinded after 2 seconds when one of the previous conditions continues to be satisfied.

The consideration of a scenario of rolling incursion, at the end of a runway and with a bad takeoff orientation (“Wrong heading for take-off”) consists, in applying the runway entry occupancy criterion and in supplementing it when it is satisfied with a comparison of the true headings of the aircraft and runway. If the true heading of the aircraft given by its flight instruments 2 differs by more than 120 degrees from that, derived from the airport database 10, of the runway considered, the scenario of rolling incursion, at the end of a runway with a bad takeoff orientation is admitted as likely and a wrong heading on takeof alarm (“Wrong heading for take-off”) is emitted in the cockpit after a confirmation lag, for example one second, by the alarm emitters 4, 5. This alarm is repeated periodically for example, every second, so long as the true heading of the aircraft differs by more than 60 degrees from that of the runway considered. It is definitively rescinded after 2 seconds when the true heading of the aircraft continues not to differ by more than 60 degrees from that of the runway considered.

FIG. 9 shows the two possible cases of presentation of an aircraft with respect to a strip of land used for takeoff and landing in both directions, one of the directions being allocated to a runway 22 and the other to a runway 23. In the case of the aircraft 25 which arrives at the entry of the runway 22 without turning its back on it, 90 degrees at most with respect to its direction, the alarm is not triggered. In the case of the aircraft 26 which arrives at the entry of the runway 23 while practically turning its back on it, more than 120° with respect to its direction, the alarm is triggered.

The consideration of an scenario of incursion, while rolling, into the intermediate part of a runway (“Entering runway intermediate”) reuses the runway presence criterion employed during the first situation analysis:

|D_{RWY}|<EPE+ALR+0.5×RW_{RWY}

and

−EPE<L_{RWY}<EPE+RL_{RWY}

If one at least of the runways of the airport in the infrastructure of which the aircraft is assumed to be rolling, satisfies this criterion, an intermediate part runway incursion scenario is assumed likely and leads, after a confirmation lag, for example of one second, to the emission in the cockpit, by the alarm emitters 4, 5, of a runway intermediate part incursion alarm (“Entering runway intermediate”). This runway intermediate part incursion alarm is repeated periodically, every second, so long as one of the following conditions is not fulfilled:

L_{RWY}>RL_{RWY}+RPL/2

or

L_{RWY}<−RPL/2

or

|D_{RWY}|>RTD/2

or

GS<33%×TSL

or

GS>133%×TSL

rescinded provisionally as soon as one of these conditions is fulfilled and rescinded definitively after 2 seconds when one of the conditions still remains fulfilled.

The consideration of a scenario of risk of runway incursion by approach to a start of a runway while rolling on the ground (“Approaching runway”), consists in comparing the aircraft's short-term forecastable position deduced from the position and the ground rolling speed of the aircraft that are given by the locating device 3 and by the flight instruments 2 with the locations, derived from the airport database 10, of the entries of the various runways of the infrastructure of the airport where the aircraft is presumed to be moving on the ground, by verifying whether there exists at least one runway RWY satisfying the criterion:

|D_{RWY}|<EPE+Max(RDT/2; ARD×GS_{XE})+ALR+0.5RW

|L_{RWY}|<EPE+Max(RPL/2; ARD×GS_{XR})

ARD being a lag defined by the relation:

ARD=Max(RDT; RPL)/TSL+ARM

ARM being a reaction lag allowed to the crew of the aircraft,
GS_{XE} is the aircraft's rolling speed component perpendicular to the axis of the runway and while closing in on the latter, and
GS_{XR} is the aircraft's rolling speed component parallel to the axis of the runway, in the latter's direction.

FIG. 10 illustrates the definition of the components GS_{XE} and GS_{XR} of the aircraft's rolling speed.

FIG. 11 shows that satisfaction of this criterion makes it possible to be sure that the aircraft will penetrate, in the short-term, if it does not modify its motion, inside a rectangular area centered on the start of a runway whose length, on the axis of the runway, is twice the sum of the uncertainty margin EPE of the locating device 3 and of the maximum of half a default exterior protection distance RPL for the ends of a runway following the runway axis and of the aircraft's forecastable travel distance parallel to the runway axis, and whose width, perpendicular to the axis of the runway, is twice the sum of the uncertainty margin EPE of the locating device 3, of the longitudinal offset ALR of the aircraft and of the maximum of half the default minimum protection spacing RTD of the runway with respect to the access linkways running alongside it and of the aircraft's forecastable travel distance towards the runway.

If one at least of the runways of the airport in the infrastructure of which the aircraft is assumed to be rolling, satisfies this criterion, a scenario of risk of runway incursion by approach to a start of a runway is assumed likely and leads, after a confirmation lag, for example one second, to the emission in the cockpit, by the alarm emitters 4, 5, of a runway entry incursion risk alert (“Approaching runway”). This runway start approach alarm is repeated periodically, every second, so long as one of the following conditions is not fulfilled:

|L_{RWY}|>RPL+EPE

or

|D_{RWY}|>RTD

or

GS<33%×TSL

or

GS>133%×TSL

rescinded provisionally when one of these conditions is fulfilled and rescinded definitively after 2 seconds when one of these conditions continues to be satisfied.

The consideration of the scenario of risk of runway incursion by approach to the intermediate part of a runway while rolling on the ground (“Approaching runway intermediate”) consists in comparing the aircraft's short-term forecastable position deduced from the position and the ground rolling speed of the aircraft that are given by the locating device 3 and by the flight instruments 2 with the locations, derived from the airport database 10, of the various runways of the infrastructure of the airport where the aircraft is presumed to be moving on the ground, while taking account of the footprint of the aircraft. This comparison is performed by verifying whether there exists at least one runway RWY satisfying the following criterion of presence on a runway area:

|D_{RWY}|<EPE+Max(RDT/2; AID×GS_{XE})+ALR+0.5RW_{RWY}

EPE+ALR<L_{RWY}<EPE+RL

AID being a lag defined by the relation:

AID=RTD/TSL+AIM

AIM being a reaction lag allowed to the crew of the aircraft.

FIG. 12 shows that satisfaction of this criterion of presence on a runway area makes it possible to be sure that the aircraft will penetrate, in the short-term, if it does not modify its motion, inside a rectangular area centered on the runway whose length on the runway axis is that RL_{RWY} of the runway plus, runway entry side, the uncertainty margin EPE of the locating device 3, and whose width perpendicular to the axis of the runway is twice the sum of the uncertainty margin EPE of the locating device 3, of the longitudinal offset ALR of the aircraft and of the maximum of half the default spacing RTD of the runway with respect to the access linkways running alongside it and of the aircraft's forecastable travel distance towards the runway.

If one at least of the runways of the airport in the infrastructure of which the aircraft is assumed to be rolling, satisfies this criterion, a scenario of risk of runway incursion by approach to intermediate part is assumed likely and leads, after a confirmation lag, for example one second, to the emission in the cockpit, by the alarm emitters 4, 5, of a risk of runway incursion alert (“Approaching runway intermediate”) which is repeated periodically for example, every second, so long as one of the following conditions is not fulfilled:

L_{RWY}>RL_{RWY}+EPE+RPL

or

L_{RWY}<−RPL−EPE

or

|D_{RWY}|>RTD

or

GS<33%×TSL

or

GS>133%×TSL

rescinded provisionally when one of these conditions is satisfied and rescinded definitively after 2 seconds when one of these conditions remains satisfied.

The consideration of a scenario of risk of runway incursion by approach to a runway intersection (“Approaching runway intersection”) consists in comparing the aircraft's current position and short-term forecastable position that are deduced from the position and ground rolling speed of the aircraft that are given by the locating device 3 and by the flight instruments 2 with the locations, derived from the airport database 10, of the runways and the runway intersections of the infrastructure of the airport where the aircraft is presumed to be moving on the ground, doing so while taking account of the footprint of the aircraft. This comparison is performed by verifying that the aircraft is on a runway and that its short-term forecastable position is not on or beyond a runway intersection. It consists in reusing the runway presence criterion employed during the first situation analysis (On RWY=1 or 0):

|D_{RWY}|<EPE+ALR+0.5×RW_{RWY}

and

−EPE<L_{RWY}<EPE+RL_{RWY}

by supplementing it with the following additional criterion tested on each runway intersection point listed in the airport database 10 for the airport concerned:

D_{IN}<GS×RID
D_{IN} being the distance of the aircraft from the runway intersection,
GS being the rolling speed of the aircraft, and
RID a reaction lag allowed to the crew of the aircraft.

FIG. 13 shows a scenario of risk of runway incursion by intersection approach on takeoff or landing. The aircraft is on a runway, on takeoff or on landing and is heading towards a runway intersection. The two previous criteria will be satisfied as soon as the aircraft encroaches into the circle 35 centered on the intersection, of radius GS×RID. From this instant onwards, a scenario of risk of runway incursion by approach to a runway intersection is assumed likely and leads, after a confirmation lag, for example one second, to the emission in the cockpit, by the alarm emitters 4, 5, of a risk of runway incursion alert (“Approaching runway intersection”) which is repeated periodically for example, every second, so long as one of the following conditions is not fulfilled:

|D_{RWY}>EPE+ALR+0.5×RW_{RWY}|

or

L_{RWY}<−EPE

or

L_{RWY}>EPE+RL_{RWY}

or

D_{IN}>2×GS×RID

or

GS<33%×TSL

or

GS>133%×TSL

rescinded provisionally when one of these conditions is satisfied and rescinded definitively after 2 seconds when one of these conditions still remains satisfied.

A scenario of risk of runway incursion by overshooting an end of a runway while rolling on the ground can cover two situations: a first situation corresponding to an aircraft rolling on a runway on the axis, with insufficient deceleration to allow it to reach a sufficiently low speed at the end of a runway and a second situation corresponding to an aircraft rolling on a runway so as to free it as quickly as possible and having a high rolling speed in proximity to the end of the runway. It is considered only for an aircraft rolling on the runway axis while being either in the deceleration phase, or in proximity to the end of a runway. It consists:
in deducing from the runway presence criterion (On RWY=1 or 0) employed in the first analysis:

|D_{RWY}|<EPE+0.5RW_{RWY}

EPE<L_{RY}<EPE+RL_{RWY}

the location of the aircraft on one or more runways,
in supplementing this runway presence criterion with a runway travel criterion consisting in adopting from among the runways satisfying the runway presence criterion only that one whose orientation is the nearest to the true heading of the aircraft, the true heading and the orientation of the selected runway having not to differ by more than ±60 degrees,
in continuing by an alternation of two criteria:
   a first criterion of insufficient deceleration consisting in the satisfaction of the set of conditions:

GS>133% TSL

μ<0

d_{B}>|L_{RWY}−EPE|
μ being the ground rolling acceleration of the aircraft, and
d_{B} a braking distance obeying the defining relation:

$${d}_{B} = \frac{1}{2 μ} [ {TSL}^{2} - {GS}^{2} ] + {M}_{B}$$

the directions of the speeds being counted negatively due to the fact that the runway vector is oriented in reverse to what is customary with the runway end as origin (FIG. 14),
M_{B} being a braking distance margin corresponding to the distance which is estimated necessary for the aircraft to stop when it rolls at the maximum permitted rolling speed TSL.
   or
a second criterion of runway rolling consisting of two sets of conditions at least one of which must be satisfied,
   a first set of conditions signifying that the aircraft is at a distance from the end of a runway that is less than the braking margin M_{B}:

GS<133% TSL

|L_{RWY}|<EPE+M_{B}
or
a second set of conditions signifying that the aircraft is rolling while accelerating although close to the end of a runway:

GS<133% TSL

|L_{RWY}|<EPE+2M_{B}

As soon as the runway presence and runway travel criteria as well as a criterion of insufficient deceleration or rolling in proximity to the end of a runway are satisfied, a scenario of risk of runway incursion by overshooting an end of a runway is assumed likely and leads, after a confirmation lag, for example 2 seconds, to the emission in the cockpit, by the alarm emitters 4, 5, of an approaching end of runway alert (“Approaching runway end”) which is repeated periodically for example, every second, and maintained until one of the criteria from which it originates is no longer satisfied for at least 4 seconds running.

The consideration of a scenario of risk of runway incursion by approach to a boarding gate (“Approaching gate”) consists in comparing the aircraft's position given by the locating device 3 with the locations, derived from the airport database 10, of the runways and boarding gates of the airport where the aircraft is presumed to be moving on the ground, so as to be sure that the aircraft is not on a runway but in the vicinity of the boarding gates. This comparison consists in verifying that the set of the distances of the aircraft with respect to the runways of the airport satisfy:
a first criterion of location away from the runways and their vicinities consisting of one of the following conditions to be complied with for the set of the runways of the airport concerned:

L_{RWY}>RL_{RWY}+RPL

or

L_{RWY}<−RPL

or

|D_{RWY}>RTD|

and
a second criterion signifying that the aircraft is within range of the boarding gates without having drawn alongside them consisting of the condition:

DG_{ARP}<500 m

DG_{ARP} being the distance from the aircraft of the nearest boarding gate.

FIG. 15 shows a scenario of risk of runway incursion by boarding gate approach (“approaching gate”). The aircraft is on a traffic area away from the runways and their immediate vicinities, and is approaching boarding gates. As soon as the off-runways location criterion and the boarding gates proximity criterion are satisfied on a certain confirmation lag, for example one second, the scenario of risk of runway incursion by approach to boarding gates is assumed likely and leads to the emission in the cockpit, by the alarm emitters 4, 5, of a boarding gate proximity alert (“Approaching gate”) which is repeated periodically for example, every second, so long as one of the following conditions is not fulfilled:

33%×TSL<GS<133%×TSL

or

DG_{ARP}<EPE+2×ALR+30 m

or

DG_{ARP}>500 m

for at least 3 seconds.

Furthermore, upon confirmation of a scenario of risk of runway incursion by approach to a boarding gate, the runway incursion alert and alarm device signals the direction with respect to the aircraft, of the nearest boarding gate. Accordingly, as shown in FIG. 16, the headings rose of the aircraft is split into four sectors: a front sector, a right sector and a left sector, each of 60° aperture, supplemented with a 180° blind rear sector. The nearest boarding gate is selected from among the boarding gates referenced from the airport database 10 on a criterion of minimum distance with respect to the aircraft and then situated with respect to the sectors of the headings rose of the aircraft to specify the boarding gate proximity alert (“Approaching gate”) through a complementary alert on the direction of the nearest boarding gate such as: nearest boarding gate ahead (“Nearest gate ahead”), nearest boarding gate on the left (“Nearest gate on left”) or nearest boarding gate on the right (“Nearest gate on right”), it being possible for the complementary alert to be substituted for the general boarding gate proximity alert.

The consideration of a scenario of risk of runway incursion by attempted takeoff outside of a runway (“Too high speed”) consists in applying two criteria:
a criterion signifying that the aircraft is preparing for takeoff:
   takeoff engine speed information given by the flight instruments 2, and
   flaps extended information given by the flight instruments 2.
      and
the off-runways presence criterion (on RWY=0, opposite of the criterion of presence on a runway On RWY=1) consisting in the realization of one of the conditions for all the runways of the airport considered:

|D_{RWY}|>EPE+ALR+0.5×RW_{RWY}

or

L_{RWY}<−EPE

or

L_{RWY}>EPE+RL_{RWY}

As soon as the preparation for takeoff criterion and the off-runways presence criterion are satisfied over a confirmation lag, for example 3 seconds, the scenario of risk of runway incursion by attempted takeoff is assumed likely and leads to the emission of a speed too high alarm (“Too high speed”) maintained so long as one of the preparation for takeoff or off-runways presence criteria is not invalidated during a cancellation lag, for example 3 seconds.

In addition to the various specific alerts and alarms of the runway incursions that may occur while the aircraft is rolling on the ground, the runway incursion alert device manages two types of alerts for the flight while approaching an airport, relating to incursions into the runways' immediate clearance space. These alerts based on the information from the GCAM equipment 6 are an airport approach alert (“Approaching airport”) and a runway approach alert (“approaching runway”).

The airport approach alert is given when the flight instruments 2 of the aircraft signal that the aircraft is in the air (landing gear unloaded or altitude greater than those of the runways of the airport considered) and when the GCAM equipment 6 signals that it is in multiple tunnel mode, that is to say it monitors to check that the aircraft remains inside a virtual volume enclosing the trajectories permitted for accessing several runways of one and the same airport.

The runway approach alert is given when the flight instruments of the aircraft signal that the aircraft is in the air (landing gear unloaded or altitude greater than those of the runways) and when the GCAM equipment 6 signals that it is in single tunnel mode, that is to say it monitors to check that the aircraft remains inside a virtual volume enclosing only the trajectories permitted for accessing a determined runway.

FIG. 17 illustrates an airport approach alert situation, the aircraft being in flight in the virtual tunnels for access to two neighboring runways.

FIG. 18 illustrates a runway alert situation, the aircraft having continued its flight from the situation of FIG. 17 so that now it is only in the virtual tunnel for access to a single runway.

The airport approach and runway approach alerts are emitted after a confirmation lag, for example 3 seconds, with regard to the information signaling the in-flight state of the aircraft and one of the items of information: multiple tunnel, single tunnel and are rescinded after a cancellation lag, for example 3 seconds, with regard to one of the previous items of information.

Several predefined scenarios analyzed for one and the same flight phase may turn out to be likely at the same instant and to justify the simultaneous emissions of several distinct alerts or alarms. To avoid disturbing the crew, the alerts or alarms are assigned a priority rank and only the alert or alarm whose priority rank is the highest is emitted in the cockpit. The table of FIG. 19 summarizes the priority ranks assigned to the various alerts and alarms, knowing that the lower the score, the higher the priority. Thus, in a predefined flight phase of rolling before takeoff (“Roll-out”), the approaching end of runway alarm has priority over the approaching a runway intersection alert. Likewise, in a predefined flight phase of rolling between a parking area and a runway (“Taxi”), the excess speed alarm has priority over the runway wrong direction alarm which itself has priority over all the other alerts and alarms.

1. A method of alerts and alarms for signaling the risk traffic zones in an airport infrastructure, to the crew of an aircraft provided with flight instruments advising on the flight phase which the aircraft is in, with a geographical locating device and with one or more emitters of audible or visual alerts or alarms, comprising the following successive steps:
selecting, on the basis of the information provided by the flight instruments and/or, by ground collision monitoring equipment GCAM, a type of flight phase from among a limited and pre-established choice of predefined types of flight phase,
selecting, on the basis of the flight phase type adopted, one or more runway incursion scenarios from among a predefined set of types of runway incursion scenarios,
analyzing the likelihood of the runway incursion scenario or scenarios adopted on the basis of the location of the aircraft provided by the locating device, with respect to the airport structures listed in an airport database, and
determining, on the basis of the runway incursion scenarios considered to be likely, the alerts and alarms to be emitted by the alerts and alarms emitters.

2. A device for implementing the method as claimed in claim 1, carried aboard an aircraft provided with flight instruments providing flight information and with a geographical locating device, generating alerts and alarms signaling risk traffic zones in an airport infrastructure, said device comprising:
an airports cartographic databank, holding a plan of the airport infrastructure and the associated traffic restrictions,
an emitter of audible or visual alerts or alarms, and
a computer locating the aircraft in the airport infrastructure stored in the airport databank on the basis of position information delivered by the locating device, analyzing the risks of runway incursion by searching for whether the current position of the aircraft and possibly its motion meets a limited number of specific and predefined situations of runway incursion or risk of runway incursion within the broad sense, termed scenarios, chosen as a function of a flight phase type selected from among a limited and pre-established choice of predefined types of flight phase, on the basis of flight information provided by the flight instruments of the aircraft, and, in the event of detecting a risk or a runway intrusion, determining the appropriate alert or alarm and triggering its emission by the alerts and alarms emitter.

3. The method as claimed in claim 1, wherein the predefined types of flight phase taken into account are:
landing,
movement on the ground, while rolling, between a parking area and a takeoff or landing runway,
the part of the takeoff where the aircraft rolls on the runway while accelerating until it reaches the liftoff speed.

4. The method as claimed in claim 1, wherein the runway incursion or risk of runway incursion scenarios taken into account are:
rolling entry to a start of a runway,
rolling entry to the end of a runway with a view to a takeoff against the runway,
rolling entry to a runway, at an intermediate level,
rolling approach to a start of a runway,
rolling approach to the intermediate part of a runway,
rolling approach to a runway intersection,
rolling approach to an end of a runway,
rolling approach to a boarding gate,
too high a rolling speed (attempted takeoff outside of a runway).

5. The method as claimed in claim 3, wherein the scenarios taken into account for the predefined type of flight phase corresponding to landing are the rolling approach to a runway intersection and the rolling approach to an end of a runway.

6. The method as claimed in claim 3, wherein the scenarios taken into account for the predefined type of flight phase corresponding to the part of the takeoff where the aircraft rolls on the runway while accelerating until it reaches the liftoff speed are the rolling approach to a runway intersection and the rolling approach to an end of a runway.

7. The method as claimed in claim 3, wherein the scenarios taken into account for the predefined type of flight phase corresponding to a rolling movement, between a parking area and a takeoff or landing runway are:
rolling entry to the start of a runway,
rolling entry to the end of a runway with a view to a takeoff against the runway,
rolling entry, to a runway, at an intermediate level,
rolling approach to a start of a runway,
rolling approach to an intermediate runway part,
rolling approach to a runway intersection,
rolling approach to a boarding gate, and
too high a rolling speed.

8. The method as claimed in claim 1, wherein when no predefined type of flight phase is recognized, no runway incursion scenario is taken into account and no alert or alarm is emitted.

9. The method as claimed in claim 1, wherein the aircraft is considered to be present on a runway (ON RWY=1) of an airport infrastructure when the component D_{RWY} normal to the axis of the runway considered, of a vector joining the aircraft to the start of one of the runways of the airport infrastructure considered, component termed axial distance of the aircraft with respect to the runway considered, is lower, in modulus, than the sum of a position error margin EPE allowed for the locating device, of the longitudinal distance ALR separating the front end of the aircraft from the airplane reference point used for its measurements, by the locating device, and of half the width of the runway RW_{RWY} considered, and when the component L_{RWY} parallel to the axis of the runway considered of the same vector, component termed longitudinal distance of the aircraft with respect to the runway considered, lies between the opposite of the error margin −EPE and the sum of the position error margin EPE and of the runway length RL_{RWY}.

|D_{RWY}|<EPE+ALR+0.5RW_{RWY}
and
−EPE<L_{RWY}<EPE+RL_{RWY}

10. The method as claimed in claim 3, wherein the predefined type of flight phase corresponding to the part of the takeoff where the aircraft rolls on the runway while accelerating until it reaches the liftoff speed is selected when the information originating from the flight instruments of the aircraft indicates:
that the aircraft is on the ground,
that its ground speed is greater than a speed maximum TSL permitted for a rolling path between a parking area and a landing or takeoff runway,
that it is accelerating,
that its flaps are extended, and
when a first analysis of the location and heading of the aircraft with respect to the airport infrastructure shows:
that the aircraft is on a runway (ON RWY=1), and
that its heading corresponds to that of the runway where it is situated.

11. The method as claimed in claim 3, wherein the predefined type of flight phase corresponding to a landing is selected when the information originating from the flight instruments of the aircraft indicates:
that it is on the ground,
that its speed is greater than a speed maximum TSL permitted for a path between a parking area and a landing or takeoff runway,
that it is decelerating, and
when a first analysis of the location and heading of the aircraft with respect to the airport infrastructure shows that:
that the aircraft is on a runway (On RWY=1), and
that its heading corresponds to that of the runway where it is situated.

12. The method as claimed in claim 3, wherein the predefined type of flight phase corresponding to a movement on the ground, while rolling, between a parking area and a takeoff or landing runway is selected when the information originating from the flight instruments of the aircraft indicates:
that it is on the ground, and
that its speed is less than a speed maximum TSL permitted for a path between a parking area and a landing or takeoff runway.

13. The method as claimed in claim 4, wherein a scenario of rolling incursion onto a start of a runway, is considered to be likely when the axial distance, taken as absolute value, |D_{RWY}| of the aircraft with respect to one of the runways of the airport infrastructure is less than the sum of:
the position error margin EPE of the locating device,
of the maximum of the distance ALR longitudinally separating the front end of the aircraft from the airplane reference point used for its measurements by the locating device and of the wingspan AWS of the aircraft, and
of half the width RW of the runway considered, and
when the longitudinal distance, in absolute value, |L_{RWY}| of the aircraft with respect to this same runway, is less than the sum of the error margin EPE and of the distance ALR longitudinally separating the front end of the aircraft from the airplane reference point used for its measurements by the locating device:

|D_{RWY}|<EPE+Max(ALR,AWS)+0.5RW
and

|L_{RWY}|<EPE+ARL

14.-15. (canceled)

16. The method as claimed in claim 4, wherein a scenario of rolling incursion onto an end of a runway with a bad takeoff orientation is considered to be likely when the conditions of the rolling scenario on a start of a runway are complied with, the modulus |D_{RWY}| of the axial distance of the aircraft with respect to one of the runways of the airport infrastructure being less than the sum of:
the position error margin EPE of the locating device,
of the maximum of the distance ALR separating the front end of the aircraft from the airplane reference point used for its measurements by the locating device and of the wingspan AWS of the aircraft, and
of half the width RW of the runway considered
and the modulus |L_{RWY}| of the longitudinal distance of the aircraft with respect to this same runway, being less than the sum of the position error margin EPE of the locating device and of the distance ALR longitudinally separating the front end of the aircraft from the airplane reference point used for its measurements by the locating device:

|D_{RWY}|<EPE+ALR+0.5RW
and

|L_{RWY}|<EPE+ARL
and
when that the heading delivered by the flight instruments of the aircraft differs by more than 120 degrees from that of the runway considered.

17.-18. (canceled)

19. The method as claimed in claim 4, wherein a scenario of rolling incursion onto the intermediate part of a runway is considered to be likely when the axial distance, taken as absolute value, |D_{RWY}| of the aircraft with respect to a runway of the airport infrastructure is less than the sum of:
the position error margin EPE of the locating device,
of the distance ALR separating the front end of the aircraft from the airplane reference point used for its measurements by the locating device, and
of half the width of the runway RW_{RWY} considered and
when the longitudinal distance L_{RWY} of the aircraft with respect to the runway considered lies between the opposite −EPE of the error margin of the locating device and the sum of the position error margin EPE and of the runway length RL_{RWY}.

|D_{RWY}|<EPE+ALR+0.5RW_{RWY}
and
−EPE<L_{RWY}<EPE+RL_{RWY}

20.-21. (canceled)

22. The method as claimed in claim 4, wherein a scenario of risk of runway incursion by rolling approach to a runway entry is considered to be likely when the axial distance D_{RWY} and the longitudinal distance L_{RWY} of the aircraft with respect to a runway satisfy the inequalities:

|D_{RWY}|<EPE+Max(RTD/2; ARD×GS_{XE})+ALR+0.5RW
and

|L_{RWY}|<EPE+Max(RPL/2; ARD×GS_{XR})
in which:
RDT is a default value of a spacing distance between the runway and an access linkway running alongside it,
ADT is a lag defined by the relation:
ARD=Max(RTD; RPL)/TSL+ARM
RPL being an exterior protection distance for the runway,
TSL being an upper limit of permitted rolling speed, and ARM a reaction lag allowed to the crew of the aircraft,
GS_{XE} is the aircraft's rolling speed component perpendicular to the axis of the runway, and
GS_{XR} is the aircraft's rolling speed component parallel to the axis of the runway.

23.-24. (canceled)

25. The method as claimed in claim 4, wherein a scenario of risk of runway incursion by rolling approach to an intermediate part of a runway is considered to be likely when the axial distance D_{RWY} and the axial distance L_{RWY} of the aircraft with respect to a runway satisfy the inequalities:

|D_{RWY}|<EPE+Max(RTD/2; AID×GS_{XE})+ALR+0.5RW
and
−EPE<L_{RWY}<RL
in which:
AID is a lag defined by the relation:
AID=RTD/TSL+AIM
AIM being a reaction lag allowed to the crew of the aircraft.

26.-27. (canceled)

28. The method as claimed in claim 4, wherein a scenario of risk of runway incursion by rolling approach to a runway intersection is considered to be likely when the distance D_{IN} of the aircraft with respect to a runway intersection satisfies the inequalities:

|D_{RWY}|<EPE+ALR+0.5RW
and
−EPE<L_{RWY}<EPE+RL
and
D_{IN}<GS×RID
GS being the rolling speed of the aircraft, and
RID a reaction lag allowed to the crew of the aircraft.

29.-30. (canceled)

31. The method as claimed in claim 4, wherein a scenario of risk of runway incursion by rolling approach to an end of a runway is considered to be likely when the following criteria are satisfied:
a first criterion of runway presence signifying that the aircraft is on the runway, consisting of the following conditions:

|D_{RWY}|<EPE+0.5RW
and
EPE<L_{RWY}<EPE+RL
a second criterion of runway travel consisting in adopting from among the runways satisfying the runway presence criterion only that whose orientation is the nearest to the true heading of the aircraft, the true heading and the orientation of the selected runway having not to differ by more than ±60 degrees, and
an alternation of two criteria:
either an insufficient deceleration criterion consisting in the satisfaction of the set of conditions:
GS>133% TSL
μ<0
d_{B}>|L_{RWY}−EPE|

μ being the ground rolling acceleration of the aircraft, and
d_{B} a braking distance obeying the defining relation:
$${d}_{B} = \frac{1}{2 μ} [ {TSL}^{2} - {GS}^{2} ] + {M}_{B}$$
the senses of the speeds being counted negatively due to the fact that the runway vector is oriented in reverse to what is customary with the runway end as origin,
M_{B} being a braking distance margin corresponding to the distance which is estimated necessary for the aircraft to stop when it rolls at the maximum permitted rolling speed TSL.
or a runway rolling criterion consisting of two sets of conditions at least one of which must be satisfied,
a first set of conditions signifying that the aircraft is at a distance from the end of a runway that is less than the braking margin M_{B}:
GS<133% TSL

|L_{RWY}|<EPE+M_{B}
or
a second set of conditions signifying that the aircraft is rolling while accelerating although close to the end of a runway:
GS<133% TSL

|L_{RWY}|<EPE+2M_{B}

32.-33. (canceled)

34. The method as claimed in claim 4, wherein a scenario of risk of runway incursion by rolling approach to a boarding gate is considered to be likely when the following criteria are satisfied:
a first criterion signifying that the aircraft is not on a runway area of the airport infrastructure, consisting of the set of conditions one of which must not be complied with:
L_{RWY}<RL+RPL
or
L_{RWY}<−RPL
or

|D_{RWY}|<RTD
RPL being a length protection margin for the runway considered, and
a second criterion signifying that the aircraft is within range of the boarding gates without having drawn alongside them, consisting of the condition:
DG_{ARP}<500 m
DG_{ARP} being the distance from the aircraft to any one of the boarding gates.

35.-37. (canceled)

38. The method as claimed in claim 4, wherein a scenario of risk of runway incursion by attempted takeoff outside of a runway is considered to be likely when the following criteria are satisfied:
a criterion signifying that the aircraft is preparing for takeoff:
takeoff engine speed information given by the flight instruments, and
flaps extended information given by the flight instruments, and
a criterion signifying that the aircraft is not on a runway, consisting of the set of conditions one of which must not be complied with:
L_{RWY}<RL+RPL
or
L_{RWY}<−RPL
or

|D_{RWY}|<RTD
RPL being a length protection margin for the runway considered.

39. The method as claimed in claim 38, wherein the likelihood of a scenario of runway incursion by attempted takeoff outside of a runway, established over a minimum confirmation lag, leads to the emission of an excessive speed alarm, which is maintained for a minimum acknowledgment lag in the course of which the likelihood criteria must no longer be satisfied.

40. The method as claimed in claim 39, wherein the minimum confirmation lag and the minimum acknowledgment lag are 3 seconds.

41. The method as claimed in claim 1, wherein the various alerts and alarms suited to the various runway incursion scenarios are associated with priority levels making it possible, upon the simultaneous detection of several incursion or risk of incursion scenarios meriting several alarms, to have the alerts or alarms emitter emit only the alert or alarm considered to be the most significant.

42. The device as claimed in claim 2, carried aboard an aircraft equipped with a GCAM ground collision prevention equipment monitoring the in-flight trajectory of the aircraft to signal to the crew of the aircraft any deviation with respect to the trajectories permitted for accessing the runways of an airport infrastructure in a multiple tunnel operating mode or with respect to the trajectories permitted for accessing a determined runway of an airport infrastructure in a single tunnel operating mode, wherein the computer triggers the emission, by the alerts and alarms emitter, of an airport proximity alert when the ground collision prevention equipment is in the multiple tunnel operating mode and of a runway proximity alert when the ground collision prevention equipment is in the single tunnel operating mode.
